(19) United States
(12) Patent Application Publication
(10) Pub. No.: US 2010/0277373 A1
(43) Pub. Date: Nov. 4, 2010

(54) Positioning Method and System

(75) Inventor: Shih Hao Chen, Hsinchu Hsien (TW)

Correspondence Address: EDELL, SHAPIRO & FINNAN, LLC, 1901 RESEARCH BOULEVARD, SUITE 400, ROCKVILLE, MD, 20850, US

(73) Assignee: MSTAR SEMICONDUCTOR, INC., Hsinchu Hsien (TW)

(21) Appl. No.: 12/731,287

(22) Filed: Mar. 25, 2010

(30) Foreign Application Priority Data
Apr. 30, 2009 (TW) 098114457

(51) Int. Cl. G01S 3/02

(52) U.S. Cl. 342/451

(57) ABSTRACT

A positioning method applied between a portable electronic apparatus, a wireless communication network and a server is provided. A positioning request signal is transmitted from the portable electronic apparatus to the server. The positioning request signal includes identity codes and signal intensities received from a plurality of base stations of the wireless communication network by the portable electronic apparatus at a predetermined position. The server compares and determines an estimated position data from a database according to the identity codes and the signal intensities from the plurality of base stations, and transmits the estimated positioning data to the portable electronic apparatus. The portable electronic apparatus considers the estimated position to determine a position data to complete positioning the predetermined position.

### CROSS REFERENCE TO RELATED PATENT APPLICATION

This patent application is based on Taiwan, R.O.C. patent application No. 098114457 filed on Apr. 30, 2009.

### FIELD OF THE INVENTION

The present invention relates to a positioning method and a positioning system, and more particularly, to a positioning method and a positioning system applied to a mobile communication network system.

### BACKGROUND OF THE INVENTION

Since the first satellite of the global positioning system (GPS) was sent into orbit by the Unite States Department of Defense, GPS has become a household word in the field of global navigation and positioning, as well as satellite measurement. As telecommunication and information technologies continue to develop, and more particularly, as the Internet and wireless data communication technologies continue to emerge, GPS positioning and measurement applications have evolved from static non-real-time measurement to dynamic real-time positioning.

GPS started off as being applied to vehicle navigation. However, it later gradually penetrated the daily life of modern people. For example, GPS integrated with an e-map is presently used for navigating a vehicle, so that a driver can arrive at a destination easily. GPS is also presently applied to leisure activities such as hiking and mountain climbing, and accordingly a hiker or climber can be guided along a route to a destination or home. Therefore, capabilities of GPS have improved the daily life of people.

However, GPS is not able to function smoothly in all places. FIG. 1 shows a schematic diagram of a GPS 1. As clearly seen in FIG. 1, a mobile receiving device 10 such as a mobile phone or a personal digital assistant (PDA) receives a satellite signal 110 transmitted from a plurality of satellites 11 orbiting around the earth 12. After receiving the satellite signal 110, the mobile receiving device 10 calculates a two-dimensional coordinate or a three-dimensional coordinate via triangulation. Therefore, a user obtains his current position via the two-dimensional or three-dimensional coordinate calculated by the mobile receiving device 10. It is apparent from the foregoing schematic diagram of GPS that, when the mobile receiving device 10 does not receive the satellite signal 110 transmitted from the satellites 11, the two-dimensional or three-dimensional coordinate can not be calculated successfully, such that the user cannot obtain the current position. Situations in which the satellite signal 110 is not received often occur in urban areas having crowded skyscrapers, or inside a building. That is, when the mobile receiving device 10 is used in urban areas having crowded skyscrapers, or inside a building, the mobile receiving device 10 has low utilization efficiency, or is of no use at all.

Therefore, in order to allow a mobile receiving device without a satellite receiver to solve the problem of GPS failures in urban areas having crowded skyscrapers or inside a building, a new function called “My Location” for Google Mobile Maps has been developed. The My Location feature has an advantage that a user-end device positions only by base stations, but this approach suffers from a disadvantage of lacking positioning accuracy. It is specified on the Google website that the My Location feature has an error range about 1000 meters. In other words, the user does not need to spend money on a GPS device to enjoy a proximate positioning service provided by Google and a position is directly displayed on Google Mobile Maps. In addition, a software positioning system called Navizon employs a wireless communication system such as a Wi-Fi system, a Global System for Mobile Communication (GSM) system, a General Package Radio Service (GPRS) system or a Wideband Code Division Multiple Access (WCDMA) system to perform positioning. That is, a large number of wireless access points distributed in various areas and mobile phone base stations are leveraged to perform positioning.

However, positioning accuracy of the above technology needs to be further improved. Therefore, a main object of the present invention is to overcome the foregoing disadvantage.

### SUMMARY OF THE INVENTION

The present invention relates a positioning auxiliary method and a positioning auxiliary device using the method. The positioning auxiliary method and the positioning auxiliary device, applied to a portable electronic device, implement signals of a wireless communication network system and a position data of a server to determine positioning auxiliary information. According to the present invention, a disadvantage of GPS failures inside a building is overcome.

A positioning method applied between a portable electronic device, a wireless communication network and a server is provided according to the present invention. The positioning method comprises transmitting a positioning request signal by the portable electronic device to the server, the positioning request signal comprising identity codes and signal intensities received from a plurality of base stations of the wireless communication network by the portable electronic device at a position; determining an estimated position data by the server according to the identity codes and signal intensities and a database stored in the server; and transmitting the estimated positioning data to the portable electronic device by the server.

A positioning method applied between a portable electronic device, a wireless communication network and a server is provided according to another aspect of the present invention. The positioning method comprises transmitting a positioning request signal by the portable electronic device to the server, the positioning request signal comprising identity codes and signal intensities received from a plurality of base stations of the wireless communication network by the portable electronic device at a position; determining estimated position data from a database by the server according to the identity codes and signal intensities; transmitting the estimated positioning data to the portable electronic device by the server; and calculating the position by the portable electronic device according to the estimated position data.

A positioning system applied to a wireless communication network is provided according to another aspect of the present invention. The positioning system comprises a portable electronic device and a server. The portable electronic device, for transmitting a positioning request signal to the server, wherein the positioning request signal comprises identity codes and signal intensities received from a plurality of base stations of the wireless communication network by the portable electronic device at a position. The server, having a database, for determining estimated positioning data from the database according to the identity codes and signal intensities and transmitting the estimated position data back to the portable electronic device.

### BRIEF DESCRIPTION OF THE DRAWINGS

Following description and figures are disclosed to gain a better understanding of the advantages of the present invention.

FIG. 1 is a schematic diagram illustrating a GPS.

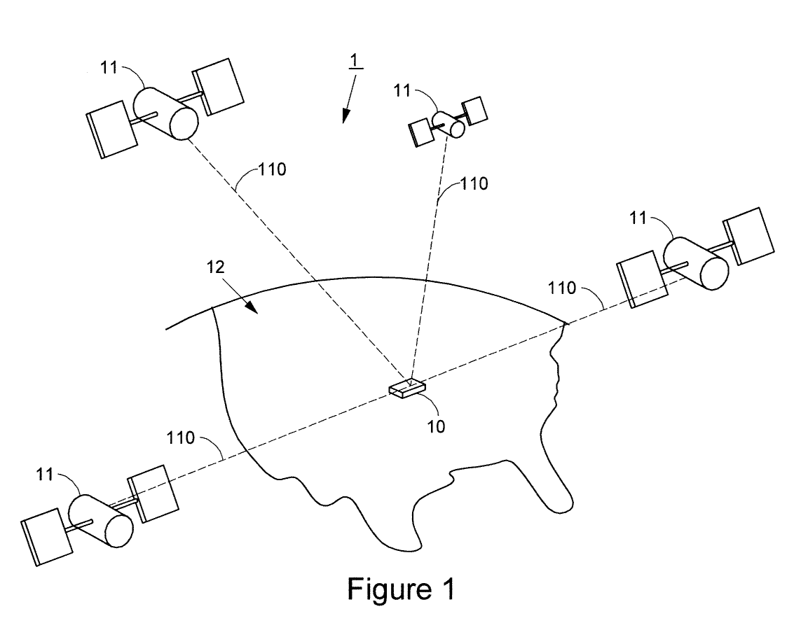

FIG. 2(a) is a block diagram of a positioning system for overcoming disadvantages of the prior art according to an embodiment of the present invention.

FIG. 2(b) is a flowchart of a positioning system for overcoming disadvantages of the prior art according to an embodiment of the present invention.

### DETAILED DESCRIPTION OF THE PREFERRED EMBODIMENT

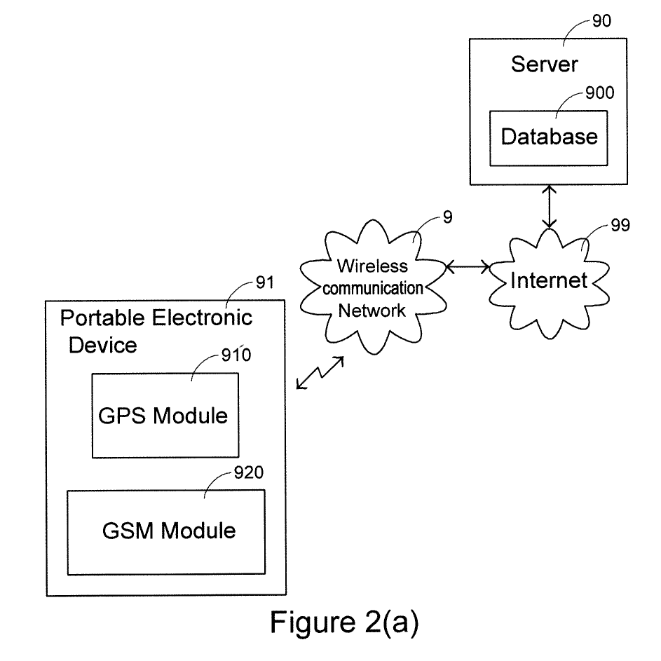

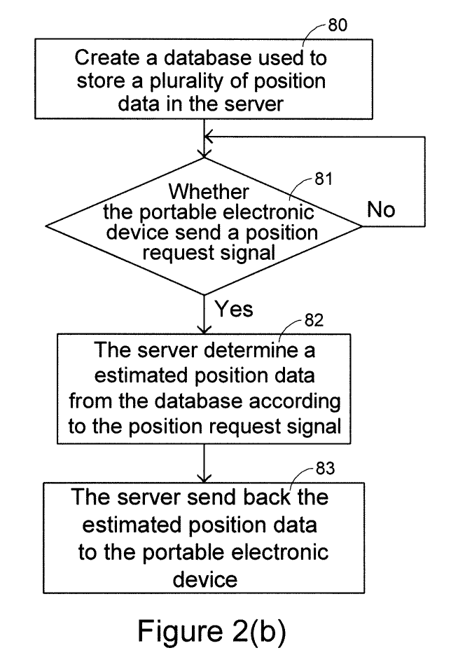

FIGS. 2(a) and 2(b) respectively show a block diagram and a flowchart of a positioning system according to an embodiment of the invention. In Step 80, a plurality of position information is stored in a server 90, which is signally connected to a wireless communication network 9 and has an internal database 900. In Step 81, a portable electronic device 91 transmits a positioning request signal to the server 90 via the wireless communication network 9. In Step 82, the server 90 compares the position information included in the received positioning request signal from the portable electronic device 91 and the plurality of position information stored in the data base 900, and determines an estimated position according to the comparison. The position information included in the received positioning request signal comprises the identity codes of corresponding base stations and the signal strength between the corresponding base stations and the portable electronic device 91 respectively. In Step 83, the estimated positioning data is transmitted back to the portable electronic device 91 from the server 90.

The following embodiments are disclosed to gain a better understanding of the technology of the present invention. The foregoing wireless communication network 9 is a common GSM or a newly developed 3G mobile phone network, a WiMAX wireless network, a Wi-Fi wireless network, or the like. The portable electronic device 91 is an electronic device, such as a mobile phone or a personal digital assistant (PDA) having a GSM communication function or a wireless access Internet function. The server 90 is connected to the wireless communication network 9 via the Internet 99 or is directly connected to the wireless communication network 9. In addition, the server 90 has the database 900 comprising a plurality of position information for comparison, and detailed content of each of the plurality of position information is illustrated as Table 1 below.

TABLE 1

| | | | | |
|---|---|---|---|---|
| 01 | BSIC-01 | ARFCN-01 | CID-01 | Rx-01 |
| 02 | BSIC-02 | ARFCN-02 | CID-02 | Rx-02 |
| 03 | BSIC-03 | ARFCN-03 | CID-03 | Rx-03 |
| . . . | | | | |
| GPS | LLA | | | |

The position information associates with various base stations, measured at a coordinate position. For example, base stations 01, 02 and 03 represent three base stations of the wireless communication network 9. An identity code for each of the base stations is represented by a unique BSIC+ARFCN code, or by CID code alone. BSIC, an acronym for Base Station Identity Code, defined in GSM specification 03.03 section 4.3.2., has six bits, three of which are network color code (NCC), and three of which are Base Station Color Code (BCC). NCC is generally allocated by national or international regulatory authority, and BCC is allocated by network operators. ARFCN, an acronym for Absolute Radio Frequency Channel Number, is a channel identity code used for identifying channels in a GSM system. Therefore, the BSIC and ARFCN are combined to an identity code of the identity of a base station. Alternatively, to identify a base station, CID, an acronym for cell identification, may also be directly used. CID is a special identity code exclusively belonging to a base station. Rx represents signal intensity data measured by a base station. A coordinate data of a GPS row represents longitude, latitude and altitude (LLA) associated with the coordinate position obtained by the GPS.

The plurality of data in the foregoing database 900 can be obtained via various approaches, and detailed thereof is to be described below. Content of the database 900 is applied to accurately position a portable electronic device unable to receive signals from the GPS, such as a portable electronic device inside a building or a portable electronic device without a GPS module. Therefore, the portable electronic device transmits a positioning request signal to the server 90 via the wireless communication network 9 or the Internet 99. The positioning request signal comprises content as illustrated in Table 2 below.

TABLE 2

| | | | | |
|---|---|---|---|---|
| 07 | BSIC-07 | ARFCN-07 | CID-07 | Rx-07 |
| 08 | BSIC-08 | ARFCN-08 | CID-08 | Rx-08 |
| 03 | BSIC-03 | ARFCN-03 | CID-03 | Rx-03 |
| . . . | | | | |

A difference between Table 1 and Table 2 is that the GPS row (containing LLA data) in Table 1 is absent in Table 2. However, Table 2 still has other information associated with a plurality of base stations of the wires communication network 9, such as identity codes (BSIC+ARFCN) and signal intensities. The server 90 then searches for data having a highest similarity to the positioning request signal from the plurality of data in the database 900, and transmits coordinate position information of the data (i.e., the LLA data in the GPS row) back to the portable electronic device, so as to complete positioning the portable electronic device.

The foregoing similarity is defined by the following two algorithms. A first algorithm compares identity codes of all base stations according to the content of the positioning request signal with each of the data stored in the database 900. Taking the CID illustrated in Table 1 and Table 2 for example, both of the data have base station 03 having a same CID. A correlation calculation is performed on signal intensities Rx corresponding to base station 03 of the two data to obtain a similarity parameter such as a difference between the two signal intensities or a square of the difference. The two data may both have N base stations having a same CID, where N is greater than 1. In such case, after performing the correlation calculation on the N pairs of signal intensities Rx corresponding to the N base stations, the similarity parameter is obtained by adding up the results from the correlation calculation and then dividing the sum by N. From the database 900, the data corresponding to the smallest similarity parameter is determined as being the nearest to a predetermined position to be estimated. Furthermore, the LLA data of the GPS row of the data is transmitted back to the portable electronic device to complete positioning the portable electronic device.

A second algorithm applies a sequence of signal intensities Rx for comparison. For example, when both of the data have N base stations having a same CID and the sequences of the signal intensities Rx corresponding to the base stations are the same, the two data are regarded as candidates. The data corresponding to N having the greatest value is selected from the candidates. When a plurality of data satisfy the foregoing condition, the first algorithm is performed to determine a data, of which the LLA data of the GPS row is transmitted back to the portable electronic device to complete positioning the portable electronic device.

In addition, a first threshold is provided in the first algorithm to gain higher accuracy. When a data having a similarity parameter smaller than the first threshold cannot be found, it means that no data is suitable for the estimation. Therefore, a second threshold larger than the first threshold is used to increase a tolerance in the data to be used for estimation; that is, a data having a similarity parameter smaller than the second threshold is used for estimating and calculating a position to complete positioning. Similarly, in the second algorithm, a plurality of data may be obtained. At this point, an algorithm using the plurality of data to estimate an estimating position is needed. This algorithm may be completed at a server end or the plurality of data is transmitted back to the portable electronic device to estimate the estimated position. An algorithm using a plurality of data to estimate an estimated position is described in Taiwan, R.O.C. patent application No. 097150480 filed on Dec. 24, 2008, and the description shall not be again given for brevity.

It is inferred from the above description that, the larger the number of the data stored in the database 900 is, the more accurate the positioning result is likely obtained. Therefore, one or any combination of the following three approaches is used to obtain the data to be stored in the database 900. A first approach is that a data is first generated by the user-held portable electronic device 91 and then transmitted to the database 900 at a regular time interval. The portable electronic device 91 has a GPS module 910 and a GSM module 920. The GPS module 910 receives signals transmitted from satellites of the GPS and calculates accurate position information such as LLA according to the signals received. The GSM module 920 is signally connected to at least one base station of the wireless communication network 9 to obtain an identity code (BSIC+ARFCN or CID) of each base station and a signal intensity data Rx of the base station. Accordingly, the database 900 collects history track data of the portable electronic device 91, and the history track data is provided to the portable electronic device 91 when the portable electronic device 91 is unable to receive signals of the GPS.

However, when the portable electronic device is not equipped with the GPS module 910 or the portable electronic device inside a building cannot receive signals transmitted from the GPS, it is still hard to provide the history track data for reference. Therefore, a second approach is to implement a certain portable electronic device signally connected to the wireless communication network 9 to generate the data; however, the portable electronic device is not limited to the user-held portable electronic device as long as it is provided with a GPS module and a GSM module. Therefore, data is generated at a position where GPS signals and GSM signals can be received at a regular time interval by the portable electronic device, such that the data is transmitted to and is stored in the database 900 of the server 90.

Supposing that it is preferred that the database 900 does not record all data generated by the portable electronic device without any limitations, or when the portable electronic device cannot find a plurality of data associated with a certain base station in the server 90, a third approach is used. In the third approach, the server 90 sends a request to at least another portable electronic device near the base station via the wireless communication network 9, so that the at least another portable electronic device transmits position information to be stored and applied in the database 900 (as illustrated in Table 1) back to the portable electronic device.

In addition, the data further records a data generating time point. Since a plurality of data associated with a same position may be recorded, an older data is updated by a newest data through comparing time points of the data.

In conclusion, it shall clearly be understood that, a portable electronic device applies wireless signals transmitted by a wireless communication network and positioning signals transmitted by a satellite positioning system, and stores identity codes and signal intensities received from base stations as well as position information to build a database for the use of positioning when a user enters an area where signals of the GPS cannot be received. Therefore, the disadvantages of the conventional positioning technology are overcome and the main object of the present invention is achieved.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A positioning method, applied between a portable electronic device, a wireless communication network and a server, the positioning method comprising:
receiving, at the server, a positioning request signal sent from the portable electronic device, the positioning request signal comprising a plurality of identity codes and a plurality of signal intensities received from a plurality of base stations of the wireless communication network by the portable electronic device at a position;
determining an estimated position data by the server according to the identity codes and signal intensities and a database stored in the server; and
transmitting the estimated positioning data to the portable electronic device by the server.

2. The positioning method as claimed in claim 1, wherein the estimated positioning data comprises a longitude data and a latitude data.

3. The positioning method as claimed in claim 2, wherein the database includes a plurality of data comprising:
coordinate position data, at least comprising longitude data and latitude data; and
identity codes and signal intensities, received from at least one base station corresponding to the coordinate position data.

4. The positioning method as claimed in claim 1, wherein the step of determining the estimated position data comprises:
comparing the positioning request signal with each data in the database by the identity codes and signal intensities and calculating a plurality of similarity parameters; and
selecting a data having a highest similarity from the database to determine the estimated positioning data according to the similarity parameters.

5. The positioning method as claimed in claim 1, wherein the step of determining the estimated position data comprises:
comparing the positioning request signal with each data in the database by the identity codes and signal intensities to generate a comparison result; and
selecting from the database at least one data having at least one same identity code with the positioning request signal to determine the estimated position data according to the comparison result.

6. The positioning method as claimed in claim 1, wherein the step of determining the estimated position data comprises:
comparing the identity codes and signal intensities with each data in the database to generate a comparison result;
sending a request to the wireless communication network and waiting for a reply from a portable base station with associated position data according to the positioning request signal when the comparison result does not correspond to any current data in the database; and
storing the associated position data to determine the estimated position data.

7. The positioning method as claimed in claim 1, wherein the database includes a plurality of data and each data is generated by the portable electronic device.

8. The positioning method as claimed in claim 1, wherein the database includes a plurality of data and at least a portion of the data is generated by another portable electronic device.

9. The positioning method as claimed in claim 1, wherein the database includes a plurality of data and each data is collected by other portable electronic devices connected to the wireless communication network according to a positioning request signal sent by the sever.

10. The positioning method as claimed in claim 1, wherein the wireless communication network using the positioning method is a Global System for Mobile communication (GSM) or a wireless network, and the portable electronic device is a mobile phone or a personal digital assistant (PDA).

11. A positioning method, applied between a portable electronic device, a wireless communication network and a server, the positioning method comprising:
receiving, at the server, a positioning request signal sent from the portable electronic device, the positioning request signal comprising a plurality of identity codes and a plurality of signal intensities received from a plurality of base stations of the wireless communication network by the portable electronic device at a position;
determining an estimated position data from a database by the server according to the identity codes and signal intensities;
transmitting the estimated positioning data to the portable electronic device by the server; and
calculating the position by the portable electronic device according to the estimated position data.

12. A positioning system, applied to a wireless communication network, the positioning system comprising:
a portable electronic device, for transmitting a positioning request signal to the server, wherein the positioning request signal comprises a plurality of identity codes and a plurality of signal intensities received from a plurality of base stations of the wireless communication network by the portable electronic device at a position; and
a server, having a database, for determining an estimated positioning data from the database according to the identity codes and signal intensities and transmitting the estimated position data back to the portable electronic device.

13. The positioning system as claimed in claim 12, wherein the estimated position data at least comprises longitude data and latitude data.

14. The positioning system as claimed in claim 12, wherein the wireless communication network is a GSM or a wireless network system, and the portable electronic device is a mobile phone or a PDA.

15. The positioning system as claimed in claim 13, wherein the database includes a plurality of data and one of the data comprises:
a coordinate position data, at least comprising longitude data and latitude data; and
identity codes and signal intensities, received from at least one base station corresponding to the coordinate position data.

16. The positioning system as claimed in claim 12, wherein the server compares the identity codes and signal intensities with each data of the database, calculates a plurality of similarity parameters, and selects a data having a highest similarity to determine the estimated positioning data according to the similarity parameters.

17. The positioning system as claimed in claim 12, wherein the server compares the identity codes and signal intensities with each data of the database to generate a comparison result, and selects from the database at least one data having at least one same identity code of a base station to determine the estimated position data.

18. The positioning system as claimed in claim 12, wherein the database includes a plurality of data and each data is generated by the portable electronic device.

19. The positioning system as claimed in claim 12, wherein the database includes a plurality of data and at least a portion of the data is generated by another portable electronic device.

20. The positioning system as claimed in claim 12, wherein the database includes a plurality of data and each data is collected by other portable electronic devices connected to the wireless communication network according to a positioning request signal sent by the sever.
